(19) United States
(12) Patent Application Publication
(10) Pub. No.: US 2011/0222696 A1
(43) Pub. Date: Sep. 15, 2011

(54) CONFIGURABLE ELECTRONIC DEVICE REPROGRAMMABLE TO MODIFY THE DEVICE FREQUENCY RESPONSE

(76) Inventors: Nikhil Balachandran, San Francisco, CA (US); Sanjay M. Bhandari, San Jose, CA (US); Srivatsan Kandadai, Santa Clara, CA (US); Horia Giuroiu, Campbell, CA (US); Jeffery D. Dugger, Atlanta, GA (US)

(21) Appl. No.: 13/046,451

(22) Filed: Mar. 11, 2011

Related U.S. Application Data
(60) Provisional application No. 61/314,110, filed on Mar. 15, 2010.

(51) Int. Cl. H04R 29/00

(52) U.S. Cl. 381/58

(57) ABSTRACT

A test signal generator provides a test signal to an acoustic device under test and a data acquisition device acquires data from the acoustic device. The initial frequency response of the signal path through the acoustic device is determined based on the test signal and the acquired data. A target frequency response is selected. A desired configuration of a configurable circuit in the signal path is determined modifying the signal path such that the frequency response of the signal path is substantially similar to the target frequency response. At least one parameter for at least one programmable component of the configurable circuit is determined and programmed into the programmable component.

### CROSS-REFERENCE TO RELATED APPLICATIONS

This application claims the benefit of U.S. Provisional Application 61/314,110 filed on Mar. 15, 2010 the contents of which is incorporated herein in its entirety.

### BACKGROUND

Audio systems may be designed to propagate a received electrical signal representing audio information through the system to an output. Many audio systems include a speaker at the output that converts the electrical signal to an acoustic signal. Ambient acoustic noise may also be present in the environment of the audio system. The ambient acoustic noise may combine with the acoustic signal emitted by the speaker such that a listener hears both the desired audio signal and the undesirable ambient noise. It may thus be desirable for the system to minimize the ambient acoustic noise to provide the listener with a better listening experience.

### BRIEF DESCRIPTION OF THE DRAWINGS

FIG. 1 is an exemplary implementation of a test system that analyzes and programs a device.

FIG. 2 is an exemplary process for using a test system.

FIG. 3A is an exemplary implementation of an acoustic device including a feedback microphone.

FIG. 3B is an exemplary implementation of an acoustic device in a test environment.

FIG. 4A is an exemplary implementation of an acoustic device including a feed-forward microphone.

FIG. 4B is another exemplary implementation of an acoustic device in a test environment.

FIG. 4C is an exemplary implementation of an acoustic device including a feed-forward microphone.

FIG. 5 is an exemplary transfer function model of an acoustic device.

FIG. 6A is another exemplary transfer function model of an acoustic device.

FIG. 6B is another exemplary transfer function model of an acoustic device.

### DETAILED DESCRIPTION

An electronic device may be characterized in terms of frequency response, which describes the relationship between an output of the device and an input of the device. It may be desirable to adjust the frequency response of an electronic device, for example to compensate the device for known non-optimal performance, to prepare the device for use in an expected environment, or to match the frequency response of the device to a target. One way to adjust the frequency response of an electronic device is to modify one or more circuit parameters in the signal path.

In one exemplary frequency response estimating system a target frequency response profile is selected for the electronic device, circuit parameters are determined such that the frequency response of the electronic device is approximately equal to the target frequency response, and the circuit parameters are programmed into the circuit. A system as described may be used in a noise control or cancellation system.

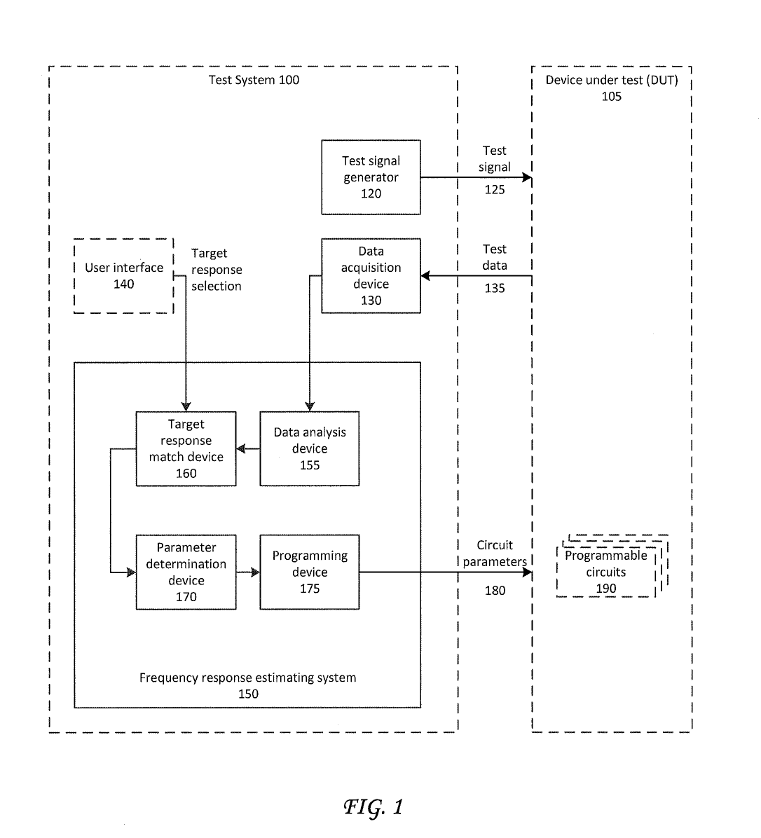

FIG. 1 illustrates an exemplary test system 100 for identifying the frequency response of an electronic device under test (DUT) 105, determining a target frequency response for DUT 105, determining a circuit configuration that will shape the DUT 105 frequency response to approximate the target frequency response, and programming DUT 105 with circuit parameters.

Test system 100 includes a test signal generator 120, a data acquisition device 130, a user interface 140, and a frequency response estimating system 150. The components of system 100 will be described below.

Device under test (DUT) 105 represents an electronic device that receives at least one input signal and generates at least one output. For example, DUT 105 may be a headphone that receives an audio signal from an audiovisual device and emits an acoustic signal from a speaker to the ear canal of a person wearing the headphone. The received input signal is propagated along a signal path that may include digital or analog components, may include transmission media, and may include the geometry of an enclosed space through which the signal propagates. For example, a signal path may include amplification and filtering circuitry including circuit board traces, as well as including the air space between a headphone speaker and a user's ear canal. Thus, the signal path may include designed elements and inherent elements. Further, design, component, and manufacturing tolerances are elements in the signal path. Each element in a signal path operates to modify a propagating signal and contributes to the frequency response of the signal path.

The term headphone as used herein includes over-ear, on-ear, and in-ear devices, including devices such as an earbud or a hearing-enhancement device, for example.

DUT 105 may include programmable circuits 190 for adjusting the frequency response of DUT 105, as described below.

Test signal generator 120 stimulates DUT 105 with a test signal of known frequency content. For example, the test signal may be a “chirp” in which the signal starts at a first frequency and ramps steadily to a second frequency at constant amplitude. As another example, the test signal may repeatedly ramp between a first frequency and a second frequency at constant amplitude. These examples are not limiting, and other test signals may include a continuous single frequency or set of frequencies or a sequence of frequencies, and a test signal may have constant or varying amplitude or phase. Further, a test signal may include pseudo-random “white noise” in which the frequency content of the white noise is at least partially unknown.

Test signal generator 120 may be off-the-shelf test equipment from a manufacturer of such equipment. Alternatively, test signal generator 120 may represent the function of signal generation in any device capable of generating a test signal. In one example, DUT 105 is a set of headphones and test signal generator 120 represents the headphone interface of a smart phone controlled by a software application loaded onto the smart phone. In this example, a user may launch the software application and select an option for generation of a test signal.

The functions of test signal generator 120 may be shared by multiple devices. In an example of shared function, test signal generator 120 is split into control and generation functions wherein the control function is part of a test application that transmits the description of a test signal to DUT 105, and a generation function in DUT 105 receives the description and generates the test signal internally.

Test signal generator 120 applies the test signal to DUT 105 via connection 125, which may be a wired or wireless connection and may represent one or more signal paths. Connection 125 may represent parallel and/or serial communication links. In one example, connection 125 is wireless and test signal generator 120 produces an audio chirp signal received by DUT 105. In another example, connection 125 is wireless and test signal generator 120 transmits a digitally-encoded test signal to DUT 105. In a further example, connection 125 is wired and test signal generator 120 transmits a test signal electrically through the wire.

When a test signal is applied to DUT 105, the response of DUT 105 is collected by data acquisition device 130. Acquisition device 130 may collect data that includes but is not limited to voltages and current, and may collect the data once, or over a period of time. The data may be gathered from multiple locations within DUT 105, and may also include circuit component status or failure information.

Data acquisition device 130 may be off-the-shelf test equipment from a manufacturer of such equipment. Alternatively, acquisition device 130 may represent the function of data acquisition in any device capable of this function. In the example above in which the test signal generator 120 was embodied in a smart phone, acquisition device 130 could represent a function of the software application on the smart phone.

The functions of acquisition device 130 may be shared by multiple devices. In an example of shared function, DUT 105 collects data about its internal circuits and provides the data to an application that stores the data in a memory for later analysis.

Data acquisition device 130 receives information via connection 135, which may be a wired or wireless connection and may represent one or more signal paths. Connection 135 may represent parallel and/or serial communication links.

The data acquired from DUT 105 may be used to characterize the response of DUT 105 as a first step in shaping the response of DUT 105 to approximate a target response. The target response may be predefined or may be selected by a user. If selected by a user, a target response may be selected through use interface 140.

User interface 140 may be used to offer a user a selection of target response options. In a non-discrete system, meaning a system operating over a continuous frequency range and/or continuous amplitude range, the number of frequency responses possible for the system is infinite. In a discrete system, meaning for example a system operating at discrete frequencies and with discrete output amplitudes, there may be a finite number of possible frequency responses. Nevertheless, the finite number could be significantly large. In either case, the number of possibilities can be prohibitively large when selecting a target response. Thus, it may be desirable to provide a user with a limited number of predefined target responses from which to select. For example, a target response option may be “maximum attenuation in the band 200-300 Hz” in a set of headphones to minimize airplane noise heard by the wearer of the headphones.

User interface 140 may be, to name a few examples, a graphical user interface (GUI), a programming interface, or a set of selection switches.

Frequency response estimating system 150 determines a desired configuration for the DUT 105 signal path using information about the target response and the data collected by data acquisition device 130. Estimating system 150 then determines circuit parameters for programmable circuits 190 such that the frequency response of DUT 105 approximates the target response. Programmable circuits 190 are described below.

Frequency response estimating system 150 includes data analysis device 155, target response match device 160, parameter determination device 170, and programming device 175.

Data analysis device 155 of frequency response estimating system 150 analyzes the data collected by data acquisition device 130. Data analysis may include using the acquired data to determine, for example, frequency response, resonances, peaks, and audio throughput. Other analyses may also be performed. The data may further be used to determine DUT 105 status such as determining component failures.

Target response match device 160 uses the selected target response and the analyses of data analysis device 155 to determine a target circuit configuration for DUT 105. The target circuit configuration would ideally cause the effective DUT 105 frequency response to match the target response. One exemplary process for determining a target circuit configuration uses control system theory, modeling DUT 105 in terms of the mathematical concept of transfer functions. This control system analysis will be described in detail below.

In some implementations, DUT 105 may include multiple circuits each with a frequency response that it is desirable to shape. For example, some DUTs 105 may include an equalization function separate from a noise cancellation function. In such implementations, target response match device 160 may include multiple heuristics for determining target circuit configurations for the various functions.

Target response match device 160 may generate solutions in a continuous domain. For example, in an equation that describes a desired circuit configuration each coefficient may be any number, limited only by constraints of the target response match device 160 such as constraints written into the software or constraints resulting from the size of a register where the coefficient is stored. If in this example the equation includes several coefficients there will be a vast number of equations that are possible. In some analog systems or in some digital signal processing systems with extensive processing capability and memory it may be possible to implement a large percentage of the continuous solutions. If, however, there are only a finite number of ways to implement a circuit configuration, the desired circuit configuration must be approximated using the options available.

Parameter determination device 170 approximates the desired circuit configuration under the constraints of the programmable circuits 190 of DUT 105. As a simple example, if the programmable circuits 190 include three parameters that may be modified and each parameter may be one of two different values, then there could be up to eight different configuration options. In this example, parameter determination device 170 might compare the expected system response resulting from each of the eight configurations and select the configuration that would cause a response most closely approximating the target frequency response according to predefined criteria.

Parameter determination device 170 may approximate a desired circuit configuration under the constraints of the discrete parameter options available in the programmable circuits 190 in a variety of ways. In the previous example, all solutions were compared to find the best solution. However, when there are several parameters each with several value options, the number of possible solutions may be prohibitively large and some other method may be better suited for finding an optimized solution in a reasonable amount of time. In one example genetic heuristics are used, starting with a seed solution and using mutation to find an optimized solution.

Target response match device 160 and parameter determination device 170 may be implemented together, such that the circuit configuration parameters are determined directly from the target response.

When the parameters for the programmable circuits have been determined by parameter determination device 170, they are then programmed into programmable circuits 190.

Programming device 175 provides programming information in proper format to DUT 105 via connection 180. Connection 180 may be wired or wireless and may be any parallel or serial communication interface appropriate for communication with DUT 105. Programming information may include information additional to configuration parameters, such as alternative parameters that may be used for different environmental conditions.

Programmable circuits 190 may be configured with the programming information received from programming device 175. Programmable circuits 190 may take many forms. In one example, programmable circuits 190 include multiple circuits in which various parameters of the circuits may be changed by selecting from among parameter configuration options. One implementation for selecting from parameter configuration options uses resistive ladder digital-to-analog converters (RLDACs) in which resistors of the RLDAC are switched in according to configuration bits in a memory location. The equivalent resistance of the RLDAC changes depending on which resistors are switched in. Values of parameters such as threshold voltages, delay settings, filter corner frequencies and the like can be changed by changing equivalent resistance.

In the example using RLDACs, as the parameters change the frequency response of DUT 105 also changes. Thus, a set of RLDACs may be used to configure DUT 105 such that the frequency response of DUT 105 approximates the target frequency response.

Other programmable circuits 190 may additionally or alternatively be used. Some examples of programmable circuits 190 include digital or analog field programmable gate arrays (FPGAs), switched capacitor circuits, transconductor-capacitor filters, and switched current circuits, to name a few.

As can be seen from the discussions above, the various components identified in test system 100 and DUT 105 may be implemented in a variety of ways. Functionality of the components may be spread across multiple devices, or may be combined as one device. The physical implementation of the components may include combinations of discrete circuitry and integrated circuitry, and the implementation may also include a combination of firmware and software.

Having described the various components of exemplary systems 100 and illustrative DUT 105, an example will now be presented.

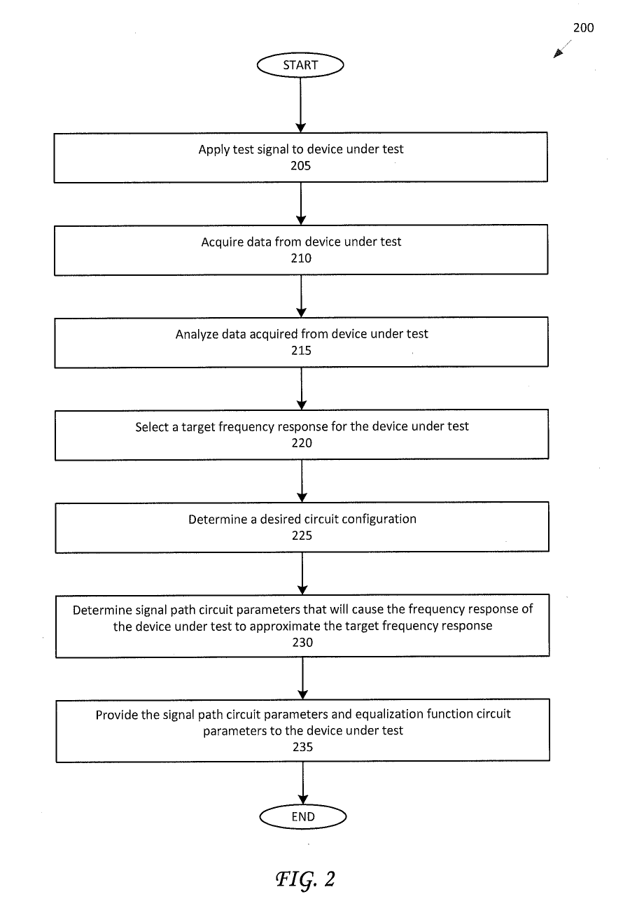

FIG. 2 illustrates an exemplary process 200 for using test system 100 to configure programmable circuits 190 such that the frequency response of DUT 105 approximates a target frequency response.

Process 200 begins at 205 when test signal generator 120 applies a test signal to device under test (DUT) 105, and continues at 210 as data acquisition device 130 acquires data from DUT 105. The acquired data is analyzed at 215 by data analysis device 155 to determine the frequency response of DUT 105.

At 220, a target frequency response is selected, either as a predetermined selection or as a user selection via user interface 140.

At 225, target response match device 160 calculates a desired circuit configuration based on the frequency response of DUT 105 and the target frequency response.

At 230, parameter determination device 170 calculates circuit parameters for the programmable circuits such that the frequency response of DUT 105 approximates the target frequency response.

At 235, programming device 175 provides the circuit parameters calculated at 235 and 240 to DUT 105 for configuration of programmable circuits 190.

Following 245, process 200 ends.

Having described generally how a test system 100 may be used to define and shape a frequency response for a DUT 105, details of some exemplary DUTs 105 are now provided as a foundation for better understanding the function of frequency response estimating system 150.

### Exemplary Acoustic Electronic Systems

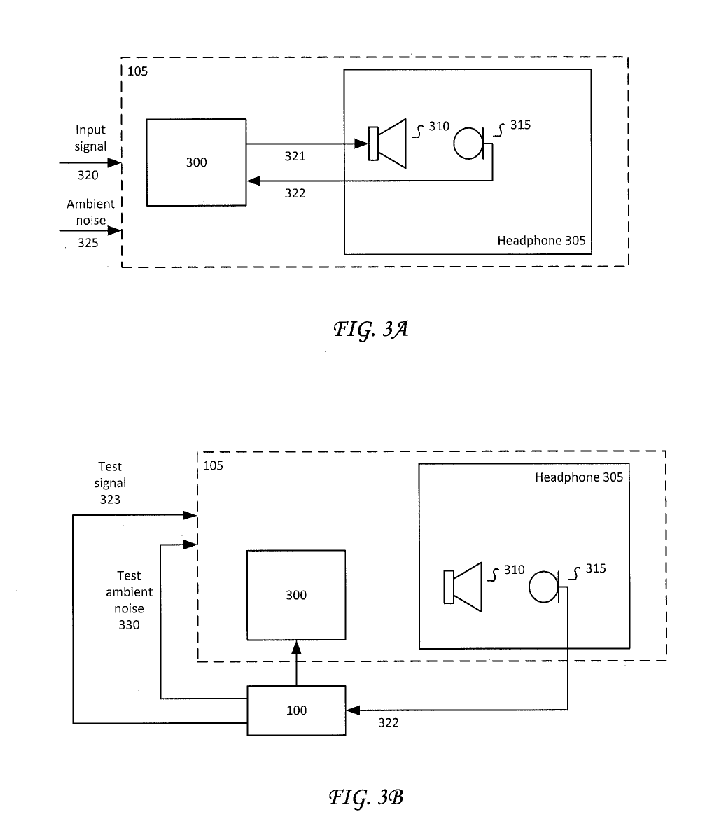

FIGS. 3A-B and 4A-C are block diagrams illustrating exemplary DUTs 105 in the field of acoustics.

FIG. 3A illustrates a block diagram for an exemplary acoustic device including a controller 300 with programmable circuits 190 (not shown) and a headphone 305 with a speaker 310 and built-in feedback microphone 315. Headphone 305 may be one of a pair of headphones 305. Controller 300 may be physically located within headphone 305. An input signal 320 propagates through controller 300 to speaker 310. Speaker 310 emits an acoustic signal representative of the propagated signal. Ambient acoustic noise 325 may also be present within headphone 305. Microphone 315 receives the acoustic signal emitted by speaker 310 and ambient noise 325, and provides a feedback signal 322 to controller 300.

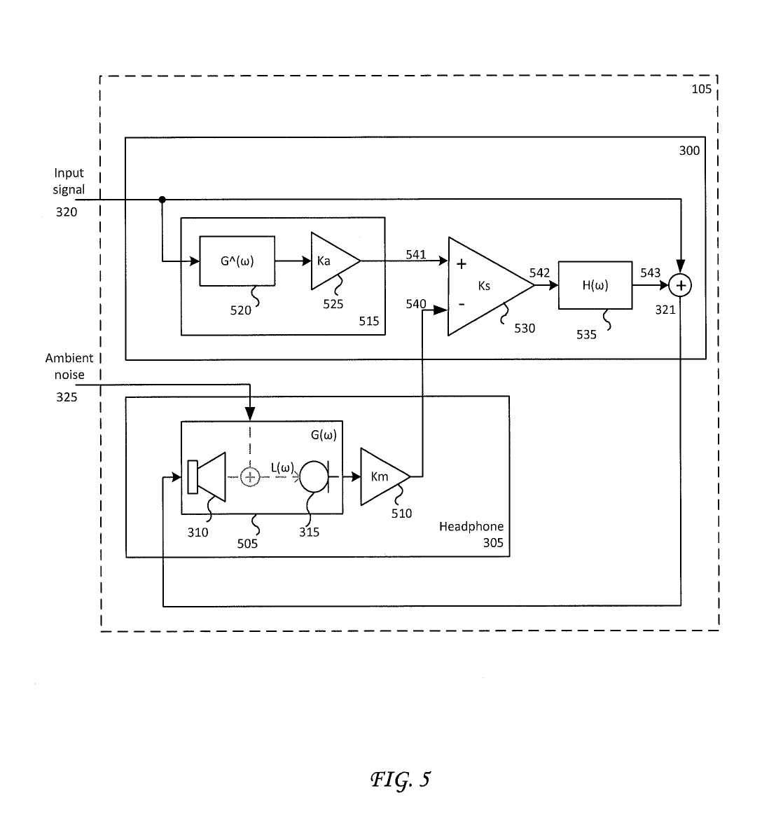

The programmable circuits 190 of controller 300 in the example of FIG. 3A may be configured at production or in a development or test environment. Additionally or alternatively, programmable circuits 190 may be programmed in an environment to compensate for the environment, by using feedback signal 322 in conjunction with a known input signal 320 to determine the programmable parameters of programmable circuits 190. A mathematical model of the exemplary closed loop system of FIG. 3A is presented in FIG. 5 and is discussed below.

FIG. 3B illustrates a block diagram for one way in which a test system 100 may be used to determine the frequency response of DUT 105 in the example of FIG. 3A. Controller 300 is shown disconnected from headphone 305, representing a bypass of controller 300 during test by, for example, removal, circumvention, or disabling. DUT 105 may include other circuits (not shown) apart from controller 300 that are not bypassed. Test system 100 may be connected to headphone 305 to provide a test signal 323 to speaker 310 and receive a feedback signal 322 from microphone 315. Test system 100 may further provide an ambient noise test signal 330 to DUT 105. Test system 100 determines the frequency response of DUT 105 and calculates circuit parameters for programmable circuits 190 in controller 300 that will cause the frequency response to be substantially similar to a target frequency response. The circuit parameters may then be programmed into programmable circuits 190.

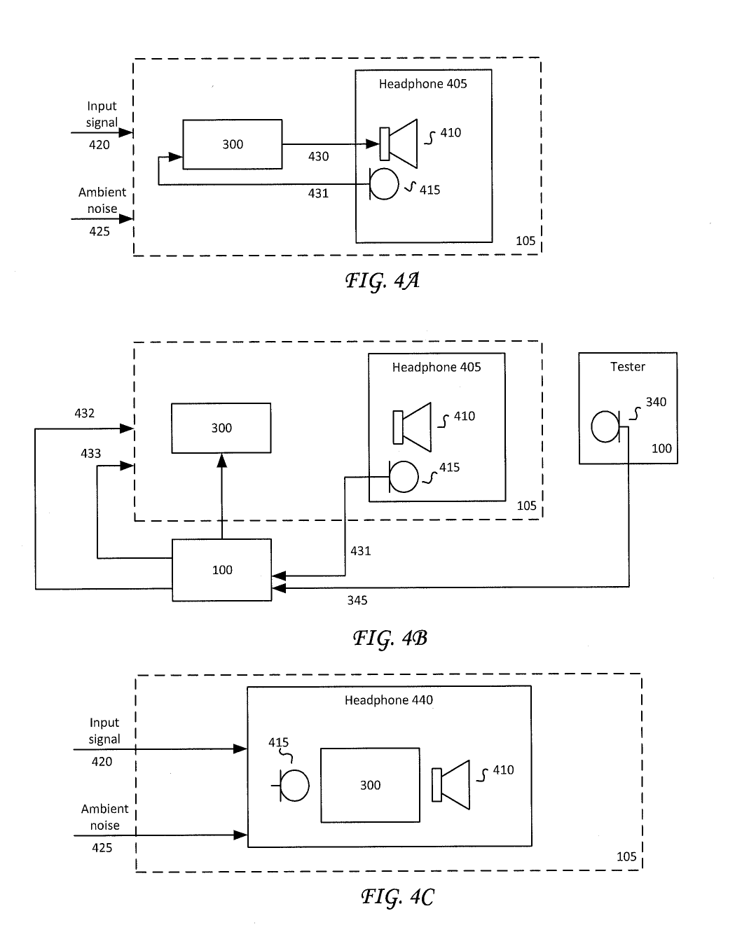

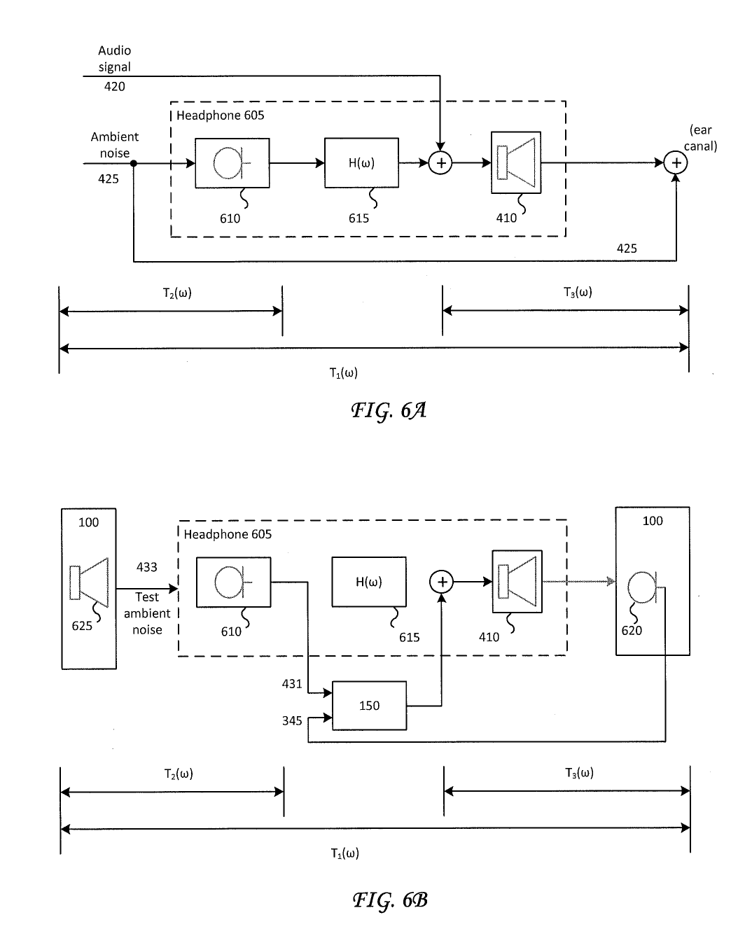

FIG. 4A illustrates a block diagram for an exemplary acoustic device including a controller 300 with programmable circuits 190 (not shown), and a headphone 405 with speaker 410 and feed-forward microphone 415. Controller 300 may be physically located within headphone 405. DUT 105 may include other circuitry not shown. In the example of FIG. 4A, microphone 415 is physically located behind or next to speaker 410. Input signal 420 propagates through DUT 105, including through controller 300, and is provided to speaker 410. Speaker 410 emits an acoustic signal representative of the propagated signal. Microphone 415 receives for the most part ambient noise 425 from the environment and provides a corresponding feed-forward signal 431 to controller 300. A mathematical model of the exemplary system of FIG. 4A is presented in FIG. 6A and is discussed below.

The programmable circuits 190 of controller 300 in the example of FIG. 4A may be configured at production or in a development or test environment. Additionally or alternatively, programmable circuits 190 may be programmed in an environment to compensate for the environment by using feed-forward signal 431 with known headphone 405 characteristics to determine the programmable parameters of programmable circuits 190.

FIG. 4B is a block diagram of the DUT 105 illustrated in FIG. 4A in a test mode. Test system 100 may be, for example, included on a head and torso simulator (HATS) in which a microphone is embedded into an ear-shaped area on the HATS to simulate noise reception in a human ear canal.

In FIG. 4B, controller 300 is shown disconnected from headphone 405, representing a bypass of programmable circuits 190 during test by, for example, removal, circumvention, or disabling. Test system 100 may be connected to headphone 405 to provide an audio test signal 432 to DUT 105 and to receive a feed-forward signal 431 from microphone 415 and a feedback signal 345 from test system 100 microphone 340. Test system 100 may further provide an ambient noise test signal 433 to headphone 405. Test system 100 uses feed-forward signal 431 and feedback signal 345 along with audio test signal 432 and ambient test noise signal 433 to determine the frequency responses for various portions of DUT 105. Test system 100 may calculate circuit parameters for programmable circuits 190 as described above. The circuit parameters may then be programmed into programmable circuits 190.

A mathematical model of the exemplary test setup of FIG. 4B is presented in FIG. 6B and is discussed below.

FIG. 4C illustrates a block diagram for an exemplary acoustic device in which a headphone 440 includes a controller 300 with programmable circuits 190 (not shown), a speaker 410, and a feed-forward microphone 415. The general operation of headphone 440 is the same as headphone 405 in the example of FIG. 4A, the distinction being that headphone 440 includes controller 300 within headphone 440. The example of FIG. 4C is included to illustrate that the components and sub-components of a DUT 105 may be physically implemented in a variety of different ways.

As mentioned, FIGS. 3A-B and 4A-C illustrate exemplary implementations of acoustic devices. These few illustrative DUTs 105 were described to provide context for the following discussions related to the mathematical concepts employed in the study of control systems.

### Exemplary Control System Models

FIGS. 5 and 6A-B illustrate exemplary implementations of control system models that may be used by frequency response estimating system 150 to determine circuit parameter information for programmable circuits 190. FIG. 5 may represent devices such as the DUT 105 illustrated in FIG. 3A. FIG. 6A may represent devices such as the DUT 105 illustrated in FIG. 4A. FIG. 6B may represent devices such as the DUT 105 illustrated in FIG. 4B. The models illustrated in FIGS. 5 and 6A-B use transfer functions to mathematically model the physical behavior of DUTs 105, according to principles of control theory.

FIG. 5 illustrates a closed loop feedback device, modeling the DUT 105 illustrated in FIG. 3A, including controller 300 and headphone 305.

Headphone 305 is modeled by transfer function 505 labeled G(ω) and microphone amplifier 510 with amplification factor Km. G(ω) is a model of the frequency response of the headphone from the input of speaker 310 through the air to the output of microphone 315. The acoustic signal received by microphone 315 is representative of the signal received at the ear canal. The signal received by the microphone is amplified by the microphone amplifier 510 and conveyed as feedback signal 540.

The controller 300 model includes an equalizer 515 including transfer function 520 labeled Ĝ(ω) and acoustic amplifier 525 with amplification factor Ka. The combination of Ĝ(ω) and Ka approximates the response of the headphone as represented by G(ω) and Km.

The controller 300 model further includes differential amplifier 530 with amplification factor Ks and error compensation circuit transfer function 535 labeled H(ω). H(ω) may represent a desired function of programmable circuits 190. The output 540 of G(ω) amplified by Km and the output 541 of Ĝ(ω) amplified by Ka are differentially amplified in amplifier 530 and provided as an input 542 to H(ω). Because Ĝ(ω) and Ka are designed to match G(ω) and Km, the output of amplifier 530 in the absence of ambient noise 325 is ideally equal to zero. The output 543 of H(ω) is added to input signal 320, and the resulting signal 321 is provided to speaker 310. L(ω) represents the combination of the acoustic signal emitted by speaker 310 and ambient acoustic noise 325. In an ideal DUT 105, signal 321 as converted to sound by speaker 310 would perfectly cancel ambient noise 325, thus L(ω) would represent only input signal 320.

The functions of controller 300 may be combined. For example, components 515 and 535 may be implemented with separate programmable circuits and a target frequency response determined for component 515 as well as for component 535. Other component combinations may also be implemented and corresponding target frequency responses determined. Controller 300 may further be implemented as one set of programmable circuits, in which case target response match device 160 may determine a desired transfer function for the device as a whole.

The model of FIG. 5 may be used as described in the following example. Undesirable noise may be received by DUT 105 and acoustically propagated to a user's ear canal. In some cases it may be expected that certain types of undesirable noise may be present. For example, expected noise may be airplane engine noise, and therefore a target frequency response for DUT 105 may be maximum attenuation of airplane engine noise translating to attenuation in the frequency band 200-300 Hertz (Hz). G(ω) may be determined based on test data acquired from DUT 105. A desired H(ω) may be calculated from G(ω) and the target frequency response such that the frequency response of DUT 105 will theoretically approximate the target frequency response. Knowing the desired H(ω), a set of parameters for programmable circuits 190 may be determined by parameter determination device 170.

A desired H(ω) may be determined, for example, by performing the calculations described by equations (1)-(6). In one implementation, H(ω) is a fourth-order controller parameterized as a vector of filter cutoff frequencies and Q-factors.

A transfer function L(ω) as shown in Equation (1) is defined as the open loop transfer function of the DUT 105 illustrated in FIG. 5 with respect to ambient noise 325.

L(ω)=Ks*Km*G(ω)*H(ω) (1)

A closed loop transfer function S(ω) is defined wherein the output is undesirable ambient noise as received by the human ear, and the input is the undesirable ambient noise received by DUT 105. S(ω) is related to L(ω) as shown in Equation (2). Minimizing S(ω) minimizes ambient noise 325 heard by the wearer of headphone 305.

S(ω)=1/(1+L(ω)) (2)

To provide the best possible noise cancellation, the minimum of S(ω) is calculated as shown in Equation (3), wherein W(ω) is a mathematical windowing function.

$$F = min {\int }_{0}^{∞} {\vert S ( ω ) \vert}^{2} * W ( ω ) * d ω \qquad ( 3 )$$

The function F is calculated subject to H(ω) and the feedback system being stable. Further, F is calculated subject to constraints on Gain Margin (GM) and Phase Margin (PM) of the feedback system. For a given GM and PM, parameters ‘a’ and ‘b’ are calculated by solving equations (4) and (5).

GM≧1/a (4)

PM≧arccos((a/b)\sqrt{1+b²−a²}) (5)

The solution for the function F is further constrained as shown in Equation (6).

|b+L(x,ω)|−|b−L(x,ω)≦2a (6)

Additional constraints on F include upper and lower limits on Q-factor, and upper and lower limits on cutoff frequency.

An optimized solution for the function F may be found in many different ways, one of which is to use a Sequential Quadratic Programming Method using an active-set strategy. There may be several minima for Equation (3) and thus several solutions for function F. It is desirable to avoid choosing a local minimum as the solution. To find a true minimum, the selected optimization method may be executed multiple times on different initial conditions to find several minima. One of the minima is then selected as the best solution in terms of, for example, attenuation, bandwidth, maximum peak, or stability of the system.

In the foregoing example, optimized function F represents a solution of filter cutoff frequencies and Q-factors for programmable circuits 190 which must be translated into circuit configuration parameters by parameter determination device 170. The resulting circuit configuration parameters may be in the continuous domain. However, programmable circuits 190 may be implemented with parameter values wherein each parameter is selected from a group of discrete values for that parameter. Thus, parameter determination device 170 must determine a set of circuit parameters that when implemented will approximate the continuous solution represented by function F. There are many ways of finding discrete solutions that approximate continuous solutions, for example by using a partial linear parametric search using limited sets of the most likely values from each group of values.

After a discrete solution is found for function F, the parameters of the solution may be programmed into programmable circuits 190.

FIG. 6A illustrates an exemplary headphone 605. Headphone 605 may represent headphone 405 with feed-forward microphone 415 as illustrated in the example of FIG. 4A.

In the example of FIG. 6A, a desired audio signal 420 is applied to speaker 410 and is broadcast to the ear canal, and an undesirable ambient noise 425 passes through headphone 605 to reach the ear canal. It is desirable to determine a transfer function H(ω) for control circuitry 615 including programmable circuits 190 that will cause undesirable acoustic ambient noise 425 heard at the ear canal to be minimized.

The path that undesirable ambient noise 425 takes from its source to the ear canal is modeled by transfer function T1(ω). Feed forward microphone 610 detects undesirable ambient noise 425. The path from the undesirable ambient noise 425 source to the microphone 610 output is modeled by transfer function T2(ω). The output of microphone 610 is passed through control circuitry 615. The output of control circuitry 615 is applied to speaker 410 along with the desired audio signal 420. The path from the input of speaker 410 to the ear canal is modeled by transfer function T3(ω).

Using this model, a transfer function H(ω) that minimizes ambient noise 425 received at the ear canal may be determined by first determining T1(ω), T2(ω), and T3(ω) and then using T1(ω), T2(ω), and T3(ω) to calculate H(ω) as shown by equations 7 and 8.

$$\begin{matrix}T 1 ( ω ) = T 2 ( ω ) \times H ( ω ) \times T 3 ( ω ) & ( 7 ) \\ H ( ω ) = \frac{T 1 ( ω )}{T 2 ( ω ) \times T 3 ( ω )} & ( 8 )\end{matrix}$$

FIG. 6B illustrates the model of FIG. 6A in a test environment configured for measuring T1(ω), T2(ω), and T3(ω) and calculating H(ω). In FIG. 6B, a test system 100 emits a test signal through speaker 625, and a microphone 620 of test system 100 is used to approximate the sound received in the ear canal. Control circuitry 615 is temporarily replaced by frequency response estimating system 150 of test system 100 for the purpose of calculating H(ω) and the configuration for programmable circuits 190 in control circuitry 615 to achieve minimization of an expected ambient noise. Test ambient noise 433 is generated to be similar to the expected ambient noise. The feedback signal from microphone 620 and the feed forward signal from microphone 610 are applied to frequency response estimating system 150 and the output of system 150 is applied to speaker 410 in headphone 605.

Transfer function T2(ω) is defined to include test system 100 speaker 625, headphone 605 microphone 610, and the acoustic path between speaker 625 and microphone 610. Transfer function T3(ω) is defined to include headphone 605 speaker 410, test system 100 microphone 620, and the acoustic path between speaker 410 and microphone 620. Transfer function T1(ω) is defined to include T2(ω) and T3(ω) as well as frequency response estimating system 150.

Using this model, T1(ω) may be determined by comparing test system 100 microphone output 345 to the input of test system 100 speaker 625, T2(ω) may be determined by comparing headphone 605 microphone output 431 to the input of test system 100 speaker 625, and T3(ω) may be determined by comparing test system 100 microphone output 345 to the output of frequency response estimating system 150. Having determined T1(ω), T2(ω), and T3(ω), H(o)) may be determined from equation (8) and parameters for programmable circuits 190 may be determined from H(ω).

A target T1̂(ω) may be selected or defined as the total system response to an expected ambient noise. For example, a target response may be selected at a user interface 140 as illustrated in FIG. 1. In some implementations the measured T1(ω) may provide a starting point for selecting or defining a target T1̂(ω).

H(ω) may be determined from target T1̂(ω) and measured T2(ω) and T3(ω) using Equation (9).

$$H ( ω ) = \frac{T 1 \hat{} ( ω )}{T 2 ( ω ) \times T 3 ( ω )} \qquad ( 9 )$$

From H(ω), parameter determination device 170 may determine circuit parameters selected from groups of discrete values.

### Exemplary Development Kit

Frequency response estimating system 150, or test system 100, may be implemented as a development kit. For example, a customer of a silicon supplier may purchase active noise cancellation (ANC) integrated circuit chips to use in a production headphone system. The term headphone includes over-ear, on-ear and in-ear devices and includes, for example, the physical headphone piece, electronic components such as speakers and microphones, control circuits, wires, and logic. Logic includes analog and digital components, firmware, and software, and encompasses the basic headphone functionality as well as the ANC functionality.

While the headphone system is under development the customer may tune the headphone system for stability, for cancellation of expected noise, and for generally shaping the frequency response of the headphone system. A development kit including frequency response estimating system 150 may be used to determine circuit parameters for the ANC chip as part of the overall headphone system tuning process. Each headphone in a pair of headphones may be tuned separately.

The development kit may include a prototype board with an ANC chip simulator. Circuit parameters determined by estimating system 150 for programmable circuits 190 are programmed into the chip simulator, and the chip simulator is used when testing the system. After the tuning process is complete, including testing using possibly multiple sets of circuit parameters, the final set of circuit parameters is saved and may be programmed into the ANC chip or chips in the headphone system.

The final set of circuit parameters may also be used as a baseline setting or as a default setting programmed into each ANC chip in a headphone system during headphone production.

### Exemplary Manufacturing Test

After a DUT 105 completes the design and development process, DUT 105 may be manufactured in quantity. In the example in which DUT 105 is a headphone system, frequency response is affected, for example, by tolerances in design or manufacture, tolerances of circuit components, or damage to the device. Thus, each new headphone may have a different frequency response. A new headphone may have an undesirable, unacceptable, or even unstable frequency response. To avoid having to discard unacceptable headphones, the headphones may be tuned at production.

Headphone systems that include a headphone pair may first go through matching, where the two headphones in the pair are matched for gain and phase. Matching allows for better perceived sound quality and for more efficient noise cancellation.

After matching, the headphone system may be tuned to meet a selected target frequency response profile using frequency response estimating system 150 as described above.

To minimize time spent tuning a headphone during production it is desirable to start the tuning process with a solution that is near the target solution. When production of the headphone first begins, the circuit parameters determined during development may optionally be used as a starting point for each headphone. Alternatively, the starting point may be, for example, a random seed set of circuit parameters, or a set of circuit parameters that was effective in production of other headphone designs.

Over time, frequency response estimating system 150 may learn from the tuning of multiple headphones to find a golden starting point that allows estimating system 150 to find a good solution for each headphone more quickly.

One production learning mechanism includes a weighting system for optimization criteria. An optimization criterion may be proximity of the headphone frequency response to the target frequency response. Proximity may be determined in multiple ways. Four ways of determining proximity of the actual frequency response to the target frequency response are: (1) comparing the ANC depth at a particular frequency point; (2) comparing the area under the ANC curve across a bandwidth BW1; (3) comparing the overall area under the ANC curve; and (4) comparing overshoots. Each of these four ways of determining proximity may be factors in the proximity criterion. The factors may be weighted and the weighted factors used to calculate the proximity criterion. Multiple criteria including proximity may also be weighted and the weighted criteria used to calculate an optimization value, which in turn may be used to determine if the current solution is an acceptable solution.

As frequency response estimating system 150 gathers increasingly more data, proximity factors such as the four listed above become statistically more informative. Thus, in one implementation, a proximity criterion may be assigned more weight as more data becomes available.

### CONCLUSION

Frequency response estimating system 150 allows for effective automated tuning of a DUT 105. Estimating system 150 may be used to shape the frequency response of a DUT 105 in a development or production environment, and further may be used to shape the frequency response of a DUT 105 in the environment of an end user. Estimating system 150 determines parameters for programmable circuits 190 that cause the frequency response of DUT 105 to approximate a target frequency response.

In some examples, frequency response estimating system 150 may be implemented at least in part as computer-readable instructions (e.g., software) on one or more computing devices (e.g., servers, personal computers, etc.).

Computing devices generally include computer-executable instructions. In general, a processor (e.g., a microprocessor) receives instructions from a computer-readable medium and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. Instructions may be transmitted by one or more transmission media, including coaxial cables, copper wire and fiber optics, including the wires that comprise a system bus coupled to a processor of a computer. Transmission media may include or convey acoustic waves, light waves, and electromagnetic emissions, such as those generated during radio frequency (RF) and infrared (IR) data communications.

Computer-executable instructions may be compiled or interpreted from computer programs created using a variety of well-known programming languages and/or technologies, including, without limitation, and either alone or in combination, Java™, C, C++, Visual Basic, Java Script, Perl, PL/SQL, Labview, etc.

In general, computing systems and/or devices may employ any of a number of well-known computer operating systems, including, but by no means limited to, known versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

Reference in the specification to “one example,” “an example,” “one approach,” “an application,” “an implementation” or similar language means that a particular feature, structure, or characteristic described in connection with the example is included in that example; however, multiple instances of such phrases does not necessarily refer to the same example.

Reference in the specification to “software” includes “firmware”, instructions built in to the hardware.

What is claimed is:

1. A system, comprising:
a test signal generator that provides a test signal to an acoustic device under test;
a data acquisition device that acquires data from the acoustic device under test representing the response of a signal path in the acoustic device under test to the test signal; and
a frequency response estimating system that:
determines an initial frequency response of the signal path based on the test signal and the data acquired by the data acquisition device;
selects a target frequency response for the signal path;
determines a desired configuration of a configurable circuit in the signal path, the desired configuration calculated to modify the signal path such that the frequency response of the signal path is substantially similar to the target frequency response;
determines from the desired configuration at least one parameter for at least one programmable component of the configurable circuit; and
causes the at least one parameter to be programmed into the at least one programmable component.

2. The system of claim 1, wherein the configurable circuit is part of an active noise cancellation integrated circuit chip.

3. The system of claim 2, wherein the target frequency response includes attenuation of an expected ambient noise.

4. The system of claim 1, wherein the configurable circuit is integrated with control circuits of the device under test.

5. The system of claim 1, wherein the device under test is a first electronic device, and wherein the at least one parameter is used as a seed solution in a reiterative calculation for finding an optimized solution for a second electronic device.

6. The system of claim 5, wherein the reiterative calculation is a genetic heuristic.

7. The system of claim 1, wherein the at least one parameter is selected from a finite group of value options.

8. The system of claim 1, wherein the target frequency response is selected based on user input.

9. The system of claim 1, wherein the device under test is a headphone.

10. A method, comprising:
providing a test signal to a device under test;
acquiring data from the device under test representing the response of a signal path in the device under test to the test signal;
determining in a frequency response estimating system the frequency response of the signal path based on the test signal and the acquired data;
selecting a target frequency response for the signal path;
determining a desired configuration of a configurable circuit in the signal path, the desired configuration modifying the signal path such that the frequency response of the signal path is substantially similar to the target frequency response;
determining from the desired configuration at least one parameter for at least one programmable component of the configurable circuit; and
causing the at least one parameter to be programmed into the at least one programmable component.

11. The method of claim 10, the configurable circuit being implemented as part of an active noise cancellation integrated circuit chip.

12. The method of claim 11, the target frequency response including attenuation of an expected ambient noise.

13. The method of claim 10, the programmable circuit being integrated with control circuits of the device under test.

14. The method of claim 10, the device under test being a first electronic device, the at least one parameter being used as a seed solution in a reiterative calculation for finding an optimized solution for a second electronic device.

15. The method of claim 14, the reiterative calculation being a genetic heuristic.

16. The method of claim 10, the parameter being selected from a finite group of value options.

17. The method of claim 10, the target frequency response being selected based on user input.

18. An electronic system, comprising:
an electronic device including a signal path; and
a test system including
a test signal generator selectively providing a test signal to the electronic device;
a data acquisition device selectively receiving test data from the electronic device;
a data analysis device that determines frequency responses for selected portions of the signal path; and
a response match device that determines a desired transfer function from the frequency responses of selected portions of the signal path and from a target frequency response selected for the signal path, the desired transfer function describing the frequency response of a programmable circuit in the signal path such that the frequency response of the signal path is substantially equivalent to the target frequency response.

19. The system of claim 18, further comprising a parameter determination device that determines at least one parameter to program into the programmable circuit based on the desired transfer function.

20. The system of claim 19, wherein the headphone is one of an earbud or a hearing enhancement device.
